(19) United States
(12) Patent Application Publication
(10) Pub. No.: US 2015/0258638 A1
(43) Pub. Date: Sep. 17, 2015

(54) METHODS AND COMPOSITIONS FOR FORMING SOLDER BUMPS ON A SUBSTRATE WITH RADIATION CURABLE OR THERMAL CURABLE SOLDER FLUX

(71) Applicant: Indium Corporation, Clinton, NY (US)

(72) Inventors: Ming Hu, Piscataway, NJ (US); Ning-Cheng Lee, New Hartford, NY (US)

(73) Assignee: Indium Corporation, Clinton, NY (US)

(21) Appl. No.: 14/657,262

(22) Filed: Mar. 13, 2015

Related U.S. Application Data
(60) Provisional application No. 61/953,611, filed on Mar. 14, 2014.

(51) Int. Cl. B23K 35/362; B23K 35/36; B23K 1/20

(52) U.S. Cl. CPC B23K 35/362; B23K 1/203; B23K 35/3613; B23K 35/3612

(57) ABSTRACT

Methods of forming solder bumps or joints using a radiation curable, thermal curable solder flux, or dual curable solder flux are disclosed. The method includes applying a liquid solder flux that is radiation curable or thermal curable to a substrate such that the solder flux covers contact pads on the substrate; placing solder balls on the contacts pads covered with the radiation curable or thermal curable solder flux; heating the substrate to join the solder balls to the contact pads, thereby forming solder bumps or solder joints; and curing the liquid solder flux by applying radiation or heat to the substrate, thereby forming a solid film. The solder flux includes radiation curable, thermally curable, or dual curable materials that aid formation of solder bumps or joints before the solder flux is cured; and are curable to form a solid material by the application of radiation or heat.

### CROSS-REFERENCE TO RELATED APPLICATIONS

This application claims the benefit of U.S. Provisional Patent Application No. 61/953,611 filed Mar. 14, 2014, which is incorporated herein by reference in its entirety.

### TECHNICAL FIELD

The present invention relates generally to a solder flux composition and methods of using the composition, and more particularly, some embodiments relate to methods of forming solder bumps or joints using a radiation curable, a thermal curable, or a dual curable solder flux.

### DESCRIPTION OF THE RELATED ART

Integrated circuits (IC) include various elements (e.g., transistors, diodes, resistors, capacitors, etc.) that are connected together by conductive material to form functional circuits. In many commercial implementations, IC include copper pads on which solder bumps are formed so that the IC may be later installed on a printed circuit board (PCB).

Reflow soldering is a well-known, conventional process in which a solder paste (e.g., a mixture of solder powder and flux) temporarily attaches electronic devices such as IC to their corresponding contact pads on a PCB. The entire assembly is then heated in a controlled fashion to melt the solder that attaches the electronic devices. Thereafter, the assembly is cooled and the solder solidifies, resulting in a permanent solder joint fastening the electronic devices to the circuit board. Heating is often accomplished by passing the assembly through a reflow oven or other controlled heat source. Reflow soldering is a common method of electrically and physically attaching electronic components to a circuit board, and is used for surface mount and through-hole mount components.

Solder flux is a liquid or semiliquid material that facilitates formation of a solder joints or solder bumps in reflow and other solder applications. Solder flux can serve a number of purposes for solder applications, but is commonly known for the fact that it improves the wetting characteristics of the liquid solder. Solder flux can be used with metal pads or solder bumps for installation of electronic devices onto printed circuit boards such as in reflow applications.

However, after the solder joint is formed and the electronic components are joined (whether by direct heat or reflow), the flux becomes a useless chemical that remains on the electronics. There have been processes developed for removing the leftover flux residue, and some have applied processing to cure the residue into a solid to reinforce the solder. This latter approach of curable solder flux described in the art was an epoxy flux that was cured by heat. However, heat curing has been less than ideal as it typically takes a longer amount of time than desired, and post heat treatment to cure the flux after the reflow operation is time consuming and costly.

UV curable materials have been used in coatings, inks, electronic coatings, adhesives, conformal coatings, and solder masks. However, such materials are not used as functional materials combined with solder flux to form a multi-function material. Some have used rosin molecules as solder flux materials. See, US 2012/0082954 A1, to Blomker et al., and US 2011/0172440 A1 to Zhang, et al.

### BRIEF SUMMARY OF EMBODIMENTS

The present disclosure describes a new technology for forming solder bumps or joints on a substrate using a radiation curable, a thermal curable, or dual curable (i.e., radiation curable and thermal curable) solder flux. More particularly, embodiments of the disclosed technology may be implemented to reduce processing steps by providing a combination of a solder flux and radiation curable, thermal curable, or dual curable materials to form solder bumps and, at the same time, form a protective film around the solder bumps as a brace coating in semiconductor components and electronic devices. Thus, the solder flux disclosed herein comprises materials that, in some embodiments, can be used in one procedure with one material to 1) function as a solder flux for forming solder bumps and 2) function as a protective film after the solder flux is fully cured.

In various embodiment the solder flux may include radiation curable, thermally curable, or dual curable (a mixture of thermal and radiation curable materials) materials that aid formation of solder bumps or joints before the solder flux is cured; and are curable to form a solid material by the application of radiation or heat. In one example embodiment, the radiation or thermally curable materials include an organic acid or modified organic acid that includes one or more UV or thermally curable functional groups, where at least one of the one or more functional groups is selected from the following: epoxy groups, vinyl ether groups, acrylate groups, or methacrylate groups.

In another example embodiment, the radiation or thermally curable materials include rosin or modified rosin that includes one or more UV or thermally curable functional groups, where at least one of the one or more functional groups is selected from the following: epoxy groups, vinyl ether groups, acrylate groups, or methacrylate groups. In implementations of this embodiment, the rosin may be UV curable. In further implementations of this embodiment, the rosin may further include one or more organic acid groups on the same molecules with the functional groups.

In a further example embodiment, the radiation or the thermally curable materials include UV curable monomers including or more of the following functional groups: epoxy groups, acrylate groups, methacrylate groups, and vinyl ether groups.

In yet a further example embodiment, the radiation or thermally curable materials include UV curable monomers and one or more adhesion promoters. In additional embodiments, the solder flux may or may not include solvents.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1A is an operational flow diagram illustrating an exemplary process of forming solder bumps or joints using a radiation curable, thermal curable, or dual curable solder flux.

FIG. 1B illustrates an example electronic device or electronic component such as a semiconductor component after various operations of the process of FIG. 1A.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS

The methods and compositions disclosed herein relate to a radiation curable (e.g., by UV, visible light, or electron beam UV), thermal curable, or dual curable solder flux composition and a method of processing such composition. The solder flux composition may be used for forming solder joints or solder bumps and it can be cured by exposure to heat, exposure to radiation (e.g., UV light, visible light or electron beam), or exposure to both after the solder joints or solder bumps are formed.

The cured solder flux could be useful in reinforced solder bumps or joints, or to protect substrates such as printed circuit boards, electronic devices or silicon (or other semiconductor material) in the case of semiconductor components. Accordingly, embodiments can reduce processing steps by providing a combination of a solder flux and radiation curable, thermal curable, or dual curable materials to form solder bumps and, at the same time, form a protective film around the solder bumps as a brace coating in semiconductor components and electronic devices. Thus, the solder flux disclosed herein in various embodiments comprises materials that can be used in one procedure with one material to 1) function as a solder flux for forming solder bumps and 2) function as a protective film after the solder flux is fully cured.

Additionally, the use of a radiation curable solder flux or a dual curable solder flux in the present disclosure provides additional benefits that may not always be realized by a solely thermal curable solder flux. First, the radiation curable materials in the solder flux permit curing after solder bumps have already formed. Second, the radiation curable materials may permit faster curing than heat curable materials. Further, the radiation curable solder flux may be used in instances where the substrate cannot withstand high temperatures.

Process

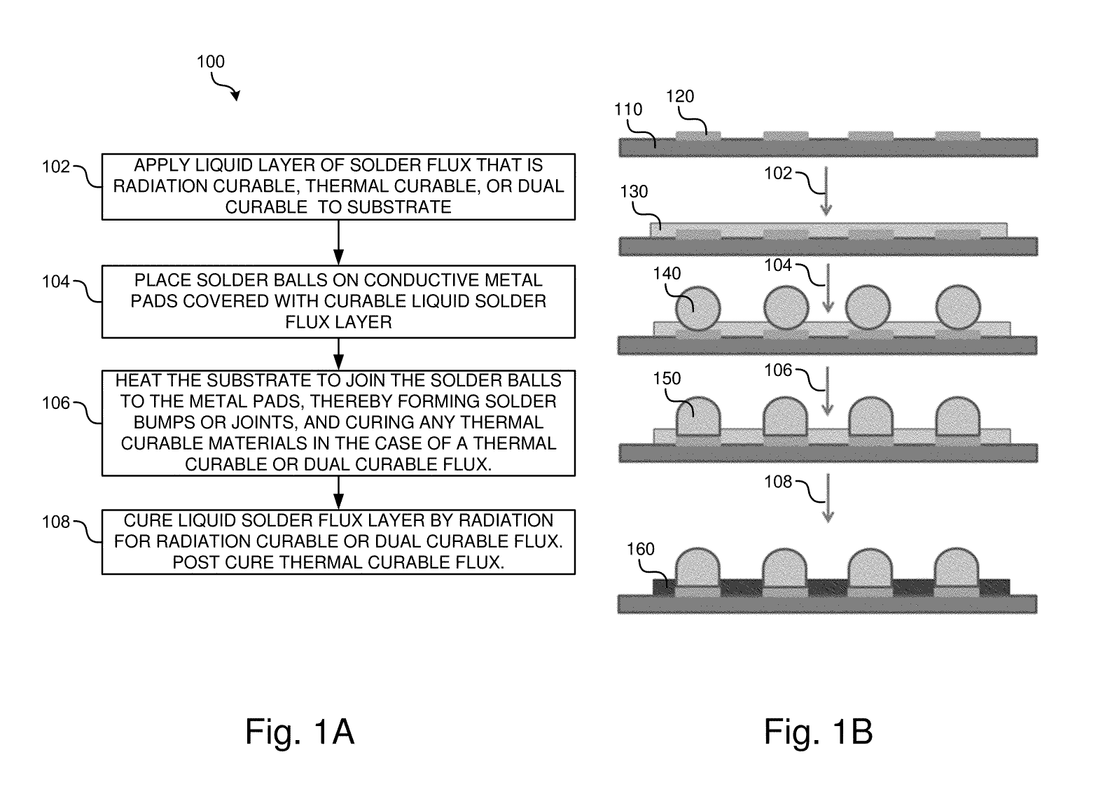

The process in various embodiments may be accomplished as shown in FIG. 1A, which is an operational flow diagram illustrating an exemplary process 100 of forming solder bumps or joints using a radiation curable, thermal curable, or dual curable solder flux. Process 100 will be described in conjunction with FIG. 1B, which illustrates an example electronic device or electronic component such as a semiconductor component after various operations of process 100. These steps are described in terms of an example application of bump bonding a chip such as a flip chip to a printed circuit board (PCB). However, after reading this description one of ordinary skill in the art will appreciate how the process can be applied to other applications such as the manufacture of ball grid arrays (BGA).

Prior to initiating process 100, a substrate 110 with one or more conductive pads 120 may be provided. For example, a chip with metallized or other conductive pads for bump bonding may be provided. At operation 102, a layer of radiation curable, thermal curable, or dual curable solder flux 130 is applied onto the substrate (e.g., by printing through a stencil or other coating techniques known in the art) such that at least the conductive pads 120 are coated. In various embodiments, the entire substrate with the pads 120 is coated. As will be further described below, the composition of flux 130 may include a plurality of mixed chemicals that render the solder flux 130 radiation curable (e.g., by application of UV light), thermal curable (by application of heat), or both radiation and thermal curable.

Next, at operation 104, solder balls 140 are placed on the flux-coated conductive pads 120. In various embodiments, the spheres can be placed manually or using automated equipment known in the art. Then, at operation 106, the assembly is heated (e.g., through a reflow process) to join the solder balls to the metal pads, thereby forming solder bumps or joints 150. In embodiments where the solder flux includes thermally curable materials (i.e., is thermal curable or dual curable), the flux will be at least partially cured after the solder melts and forms a solder bump on the metallized pad. In embodiments where the flux is only thermal curable, flux 130 may harden into solid film, such that no post thermal curing may be needed. In this scenario, operation 108 may be skipped.

After the bumps or joints are formed, the curable flux is cured into solid film 160 at operation 108 by the application of radiation in the case of a radiation curable or dual curable solder flux. In various embodiments, the flux may be cured by radiation such as, for example, UV or visible light or an electron beam. It is worth nothing that in the case of a dual curable flux, after operation 106 (e.g., reflow) to form the solder bumps, the thermally curable chemicals may cure, thereby causing the flux to form a mixed solid or semisolid material with radiation curable materials trapped inside. In such scenario, the radiation cure at operation 108 completes the curing (solidification) process. In embodiments where the solder flux is only thermally curable or dual curable, the substrate may be post baked at operation 108 for further curing.

Thereafter, the cured solder film may reinforce solder bumps or joints, or protect substrates such as printed circuit boards, electronic devices or silicon (or other semiconductor material) in the case of semiconductor components.

Solder Flux Composition

In various embodiments, the solder flux composition includes chemicals selected to help form solder bumps or joints and that could be cured into solid materials by irradiation, heating, or a combination of both. For example, in one embodiment the solder flux is UV curable, and the flux may be used as a wafer applied coating for a chip scale package for ball attachment processing. In this embodiment, the solder flux may partially under fill a wafer-level chip-scale package (WLCSP) die at the wafer level. In an additional embodiment, a UV curable, thermal curable, or UV curable and thermal solder flux could be used in any place on the substrate as a protective material when the solder bump or joint is formed. In further embodiments, any leftover solder flux may be cured by irradiation or heating into a protective material. In a preferred embodiment, the UV curable flux may comprise anionic or free radical UV curable materials as well as solder flux for the same material. In additional embodiments, the solder flux may include chemicals that may be partially cured by heat and then cured by UV light, visible light, electron beam, or other radiation source.

During application, the radiation or thermal curable chemicals may provide the additional functionalities of cleaning and removing metal oxide on the solder and reducing oxidation on the solder metal or substrate metal during reflow soldering processes.

Specific embodiments of chemical compositions that may be used in the solder flux composition are outlined below.

In a first embodiment, the composition comprises rosin or UV curable rosins. The rosin may be any molecule with the base structure of an acrylated acid, illustrated below as Structure 1, and its derivatives.

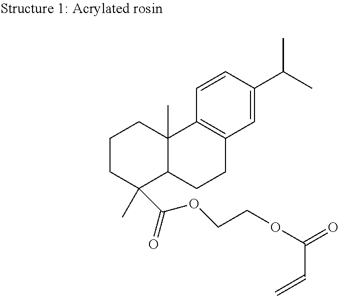 [SMILES: C=CC(=O)OCCOC(=O)C1(C)CCCC2(C)c3ccc(C(C)C)cc3CCC12]

The UV curable rosins may be rosin molecules with one or more UV curable functionalities such as acrylate, methacrylate, vinyl, vinyl ether or epoxy functionalities. Example of UV-curable rosin structures that may be implemented in embodiments are illustrated below as Structures 2-7.

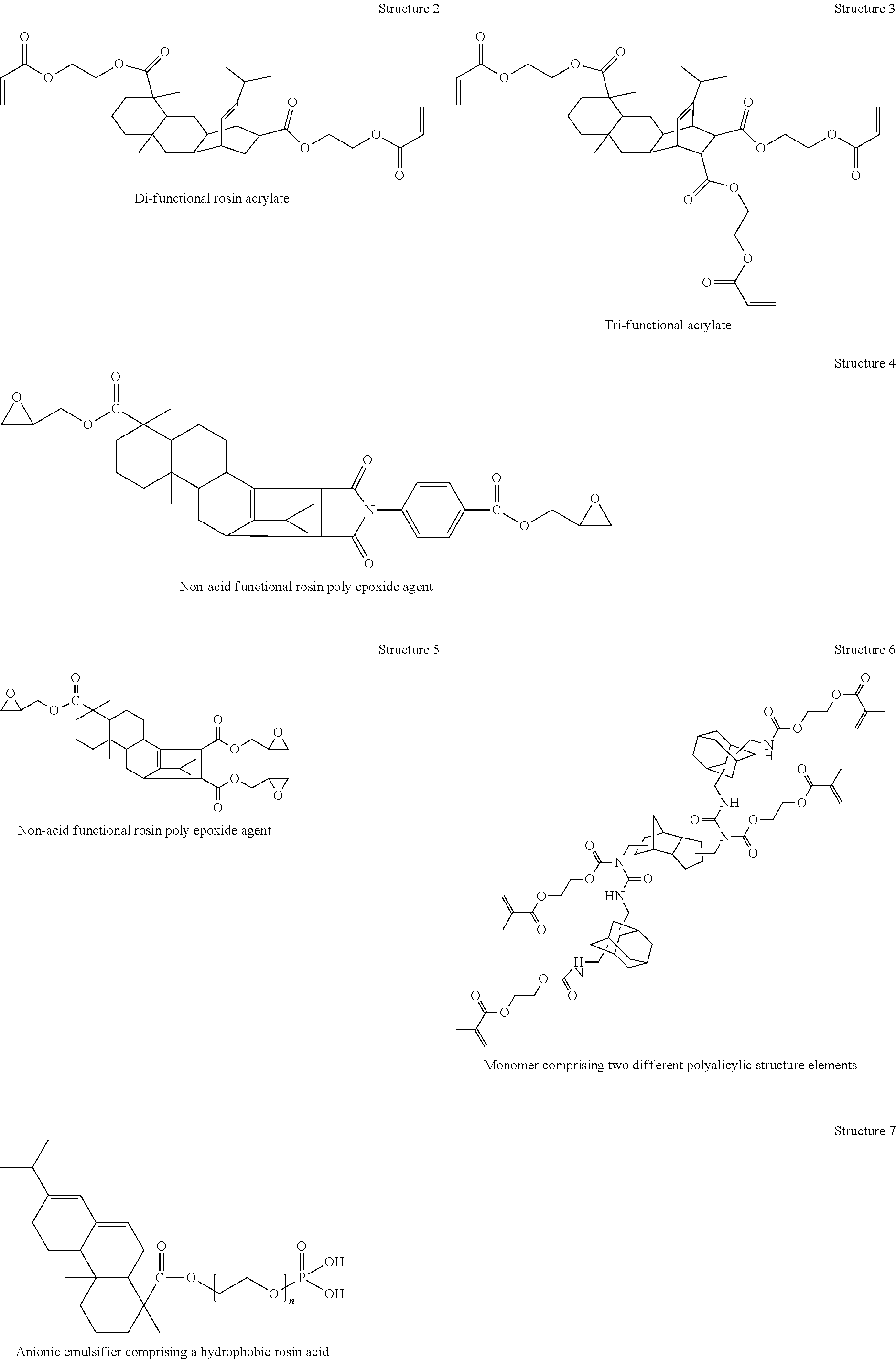

In a second embodiment, the composition may comprises a UV curable acid or heat curable acid, which can be, for example, a di-acid. Examples structures of UV curable acids that may be implemented in embodiments are illustrated below as Structures 8-12.

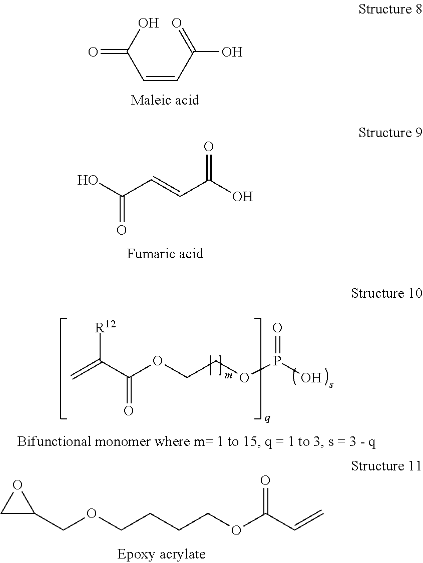

In a third embodiment, the composition may comprises an acrylated acid such as 2-carboxyethyl acrylate (CH₂═CHCO₂(CH₂)₂CO₂H). In a fourth embodiment, the composition may comprise synergists and UV curable amine synergists such as, for example, 2-(Dimethylamino)ethyl acrylate (H₂C═CHCO₂CH₂CH₂N(CH₃)₂), 2-(Diethylamino)ethyl acrylate (CH₂═CHCOOCH₂CH₂N(C₂H₅)₂), and triethanolamine ((HOCH₂CH₂)₃N).

In a fifth embodiment, the UV curable flux may also contain a heat curing agent such as anhydride. In this embodiment, the flux is at least partially cured by heat. Example of anhydrides that may be implemented in embodiments are illustrated below as Structures 13-26.

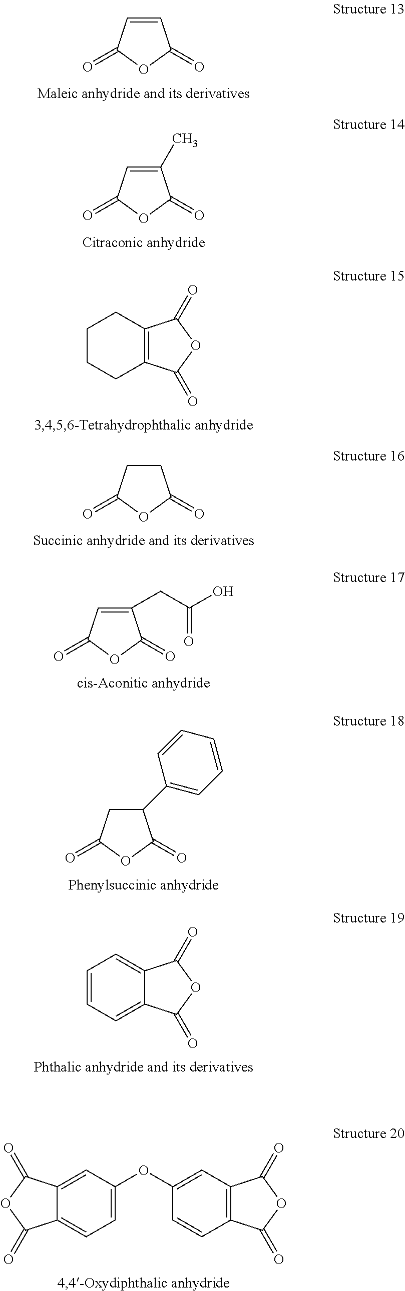

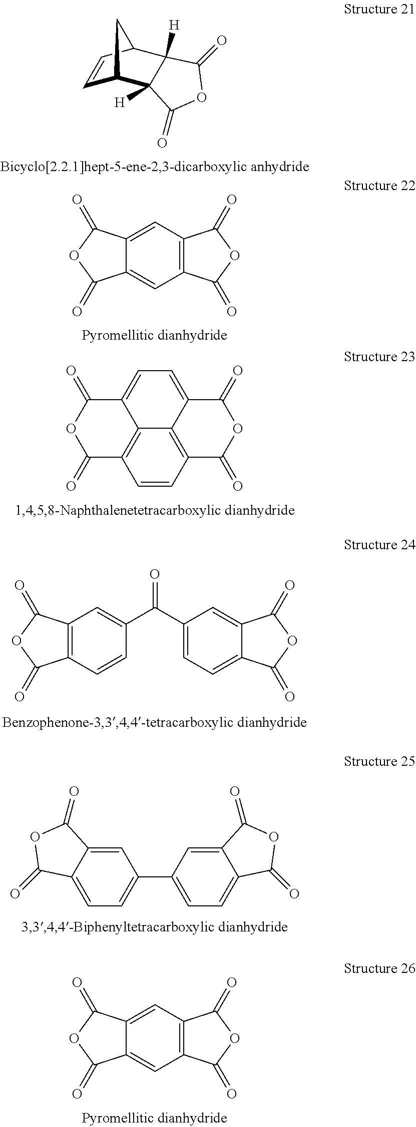

In a sixth embodiment where the flux is radiation curable, the flux may comprise at least one or more photoinitiator chemicals. In particular implementations of this embodiment, the flux may comprise one or more free radical photoinitiators and/or one or more cationic photoinitiators to initiate a free radical polymerization reaction or cationic polymerization reaction or initiate both reactions as a dual cure UV polymerization mechanism. Examples of cationic photoinitiators that may be implemented in embodiments are illustrated below as Structures 27-30. Examples of free radical photoinitiators that may be implemented in embodiments are illustrated below as Structures 31-34.

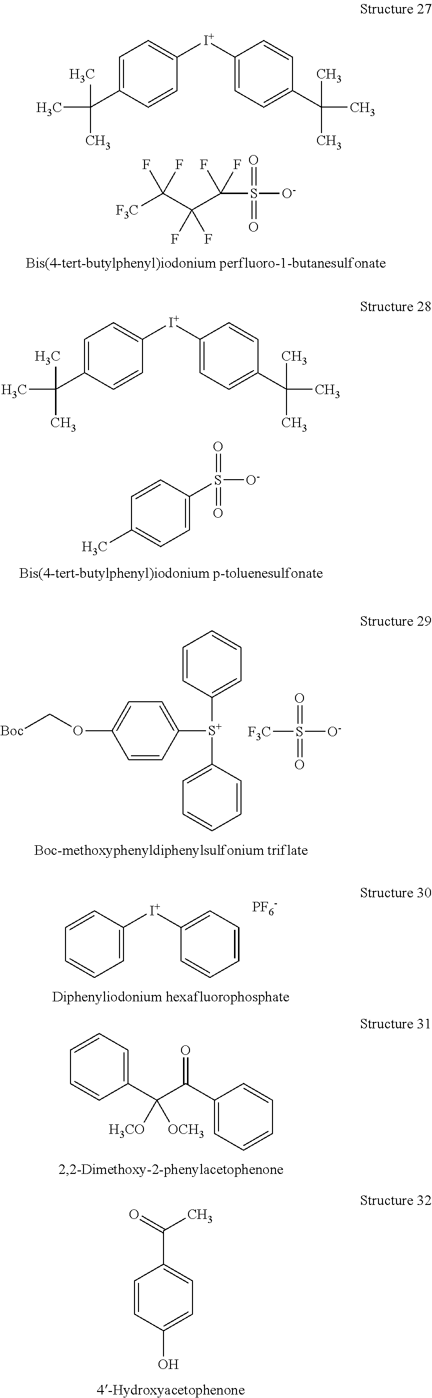

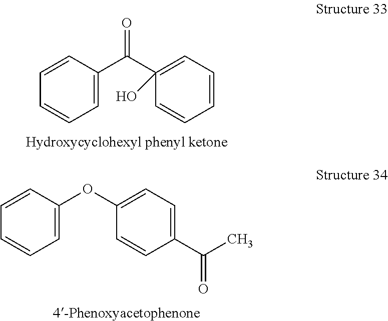

In a seventh embodiment, the flux may comprise adhesion promoters or UV curable adhesion promoters. Examples of adhesion promoters that may be implemented in embodiments are illustrated below as Structures 35-36.

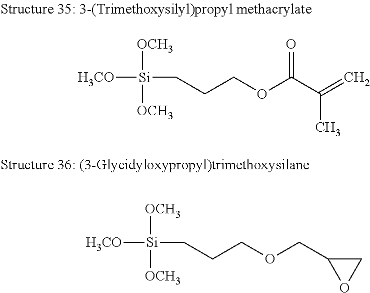 [SMILES: C=C(C)C(=O)OCCC[Si](OC)(OC)OC ; CO[Si](CCCOCC1CO1)(OC)OC]

In an eighth embodiment, the flux may comprise UV curable monomers and oligomers such as acrylate, methacrylate, epoxy or vinyl ethers. For example, the flux may comprise UV curable materials such as acrylate esters, acrylate urethanes, or acrylate epoxies. As another example, the flux could also include epoxies used in cationic curable materials. Examples of UV curable monomers and oligomers that may be implemented in embodiments are illustrated below as Structures 37-48.

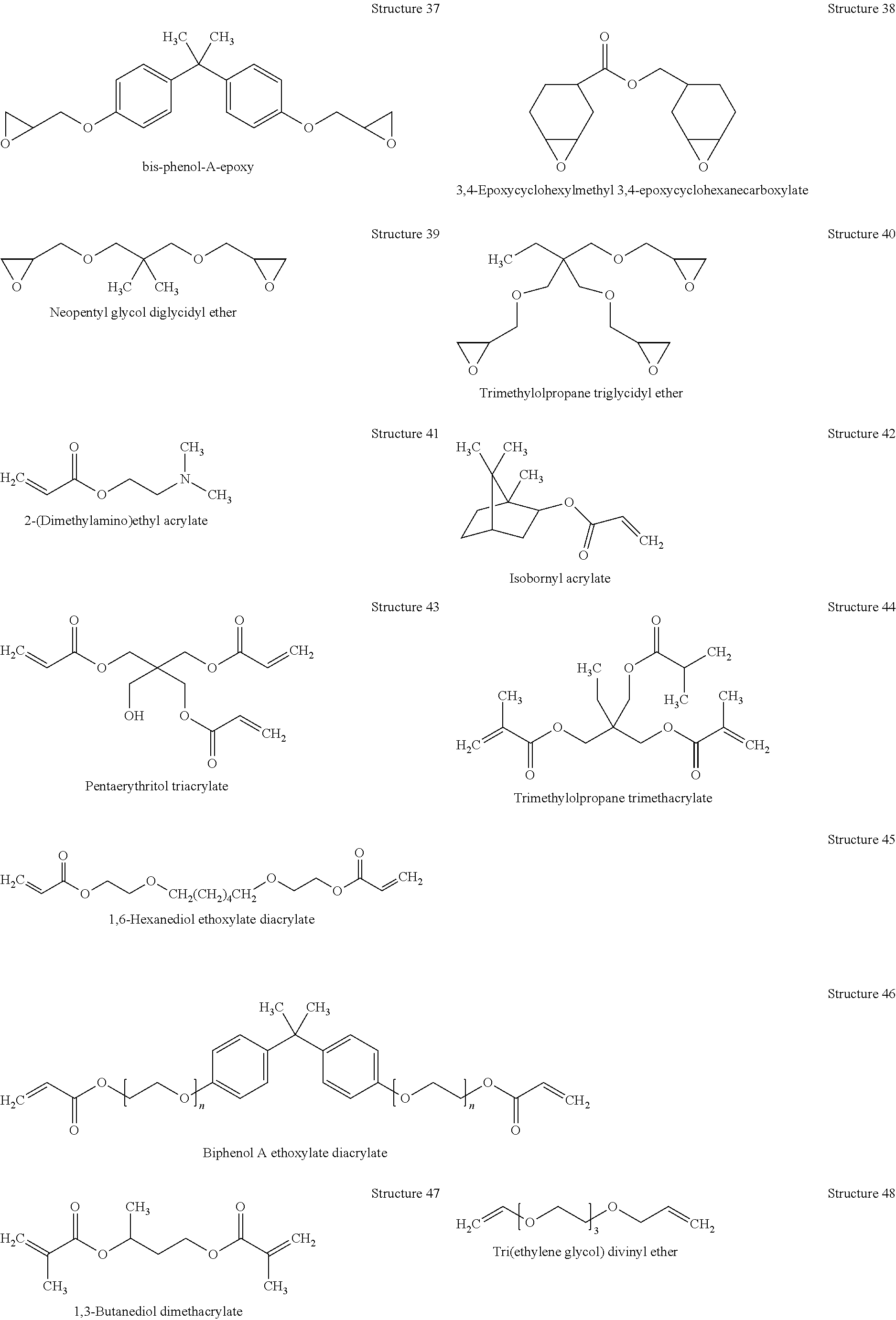

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method, comprising:
applying a liquid solder flux that is radiation curable or thermal curable to a substrate such that the solder flux covers one or more contact pads on the substrate;
placing solder balls on the contacts pads covered with the radiation curable or thermal curable solder flux;
heating the substrate to join the solder balls to the contact pads, thereby forming solder bumps or solder joints; and
curing the liquid solder flux by applying radiation or heat to the substrate, thereby forming a solid film.

2. The method of claim 1, wherein the solder flux is radiation curable, and wherein curing the liquid solder flux comprises applying radiation to the liquid solder flux.

3. The method of claim 2, wherein the radiation comprises at least one of UV light, visible light, or an electron beam.

4. The method of claim 3, wherein the radiation comprises UV light.

5. The method of claim 3, wherein the solder flux is thermal curable and radiation curable, and wherein the solder flux is partially cured during the step of heating the substrate.

6. The method of claim 5, wherein the solder flux comprises at least two of acrylate, methacrylate, epoxy, vinyl ether, or anhydride.

7. The method of claim 3, wherein the solder flux comprises at least one or more photoinitiators.

8. The method of claim 7, wherein the solder flux comprises a free radical photoinitiator and a cationic photoinitiator.

9. The method of claim 1, wherein the substrate is a substrate of a flip chip.

10. A solder flux, comprising radiation or thermally curable materials, and wherein the radiation or the thermally curable materials:
aid formation of solder bumps or solder joints before the solder flux is cured; and
are curable to form a solid material by the application of radiation or heat.

11. The solder flux of claim 10, wherein the solder flux comprises radiation and thermally curable materials, and wherein the radiation and thermally curable materials comprise at least two of: acrylate, methacrylate, epoxy, vinyl ether, and anhydride.

12. The solder flux of claim 11, wherein the solder flux comprises anhydride.

13. The solder flux of claim 10, wherein the radiation or the thermally curable materials comprise an organic acid or modified organic acid that includes one or more UV or thermally curable functional groups, wherein at least one of the one or more functional groups is selected from the following: epoxy groups, vinyl ether groups, acrylate groups, or methacrylate groups.

14. The solder flux of claim 10, wherein the radiation or the thermally curable materials comprise rosin or modified rosin that includes one or more UV or thermally curable functional groups, wherein at least one of the one or more functional groups is selected from the following: epoxy groups, vinyl ether groups, acrylate groups, or methacrylate groups.

15. The solder flux of claim 14, wherein the rosin is UV curable.

16. The solder flux of claim 14, wherein the rosin further comprises one or more organic acid groups on the same molecules with the functional groups.

17. The solder flux of claim 10, wherein the radiation or the thermally curable materials comprise one or more photoinitiators.

18. The solder flux of claim 15, wherein the one or more photoinitiators comprises a free radical photoinitiator and a cationic photoinitiator.

19. The solder flux of claim 10, wherein the radiation or the thermally curable materials comprise UV curable amine synergists.

20. The solder flux of claim 10, wherein the radiation or the thermally curable materials comprise UV curable monomers and one or more adhesion promoters.

21. The solder flux of claim 10, wherein the radiation or the thermally curable materials comprise UV curable monomers comprising or more of the following functional groups: epoxy groups, acrylate groups, methacrylate groups, and vinyl ether groups.

22. The solder flux of claim 10, wherein the solder does not comprise any solvents.
